(19) United States
(12) Patent Application Publication
(10) Pub. No.: US 2026/0005405 A1
(43) Pub. Date: Jan. 1, 2026

(54) BATTERY MODULE

(71) Applicant: SAMSUNG SDI CO., LTD., Yongin-si (KR)

(72) Inventors: Si Seong KANG, Suwon-si (KR); Gun Yeob PARK, Suwon-si (KR); Soo Deok MOON, Suwon-si (KR)

(21) Appl. No.: 19/025,464

(22) Filed: Jan. 16, 2025

(30) Foreign Application Priority Data
Jun. 26, 2024 (KR) 10-2024-0083446

(51) Int. Cl. H01M 50/507; H01M 50/516

(52) U.S. Cl. CPC H01M 50/507; H01M 50/516

(57) ABSTRACT

A battery module includes a housing; one or more battery cells arranged in the housing and including a cell terminal; a bus bar holder above the one or more battery cells and including an opening through which the cell terminal is exposed; and a bus bar supported by the bus bar holder, connected to the cell terminal, and including a first surface and a second surface located in a direction opposite to the first surface, and the bus bar holder includes a first support portion that is in contact with the first surface, and a second support portion spaced apart from the first support portion and in contact with the second surface.

### CROSS-REFERENCE TO RELATED APPLICATION

The present application claims priority to and the benefit of Korean Patent Application No. 10-2024-0083446, filed on Jun. 26, 2024 in the Korean Intellectual Property Office, the entire disclosure of which is incorporated herein by reference.

### BACKGROUND

### 1. Field

Aspects of embodiments of the present disclosure relate to a battery module.

### 2. Description of the Related Art

Secondary batteries are capable of both charging and discharging, unlike primary batteries that cannot be recharged. Low-capacity secondary batteries may be used in portable small electronic devices, such as smartphones, feature phones, laptop computers, digital cameras, and camcorders, while high-capacity secondary batteries are widely used as power sources for motor driving in hybrid vehicles, electric vehicles, and the like, and batteries for power storage, or the like. The secondary battery includes an electrode assembly composed of a positive electrode and a negative electrode, a case that accommodates the electrode assembly, and an electrode terminal connected to the electrode assembly.

The secondary battery may be used as a battery pack formed of a plurality of unit battery cells connected in series and/or parallel to provide high energy density. The battery pack may be formed by interconnecting the electrode terminals of a plurality of unit batteries to meet a required amount of power, and to implement a high-power secondary battery of, for example, an electric vehicle.

The above information disclosed in this Background section is provided for enhancement of understanding of the background of the present disclosure, and, therefore, it may contain information that does not constitute related (or prior) art.

### SUMMARY

According to an aspect of one or more embodiments of the present invention, a battery module that can improve assembly tolerance and improve a fixing force in a vertical direction by fixing a bus bar in a bus bar holder in the vertical direction is provided.

The above and other aspects and features of the present disclosure will be described in or will be apparent from the following description of some embodiments of the present disclosure.

According to one or more embodiments of the present invention, a battery module includes a housing; one or more battery cells arranged in the housing and including a cell terminal; a bus bar holder above the one or more battery cells and including an opening through which the cell terminal is exposed; and a bus bar supported by the bus bar holder, connected to the cell terminal, and including a first surface and a second surface located in a direction opposite to the first surface, and the bus bar holder includes a first support portion that is in contact with the first surface, and a second support portion spaced apart from the first support portion and in contact with the second surface.

The first support portion may press the bus bar in a first direction, and the second support portion may press the bus bar in a direction opposite to the first direction.

The bus bar may include a first bending portion bent in the direction opposite to the first direction, and a pair of plates at opposite sides of the first bending portion, covering the opening, and in contact with the cell terminal.

The pair of plates may include a second bending portion bent in the first direction.

The first support portion may protrude from the bus bar holder in the first direction and include an elastic portion that elastically supports the first bending portion.

The elastic portion may include a first body portion bent in the direction opposite to the first direction, and a second body portion at opposite sides of the first body portion and bent in the first direction.

The bus bar holder may include a through-hole portion formed in a second direction intersecting the first direction.

The first bending portion may include a slit hole portion formed in the second direction.

The first support portion may be located in an inner area of the through-hole portion.

The through-hole portion may be located between a plurality of openings.

The second support portion may include a hook that extends from the bus bar holder in the first direction and is caught on and is in contact with the pair of plates.

A plurality of second support portions may be spaced apart along an edge of the opening.

The second support portion may pass through the slit hole portion.

The second support portions may be between the plurality of openings.

The bus bar holder may include a recessed hole (e.g., a long recessed hole) between the plurality of openings.

The recessed hole may be formed in a third direction intersecting the first direction and the second direction.

The first support portion may include a first elastic portion extending obliquely from the bus bar holder in the first direction, and a second elastic portion facing the first elastic portion, spaced apart from the first elastic portion, and extending obliquely from the bus bar holder in the first direction.

The first support portion may further include a seating protrusion protruding from free ends of the first elastic portion and the second elastic portion and on which the plate is seated.

The first support portion may be located at an edge of the opening.

### BRIEF DESCRIPTION OF THE DRAWINGS

The drawings attached to this specification illustrate some example embodiments of the present disclosure, and further describe aspects and features of the present disclosure together with the detailed description of the present disclosure. However, the present disclosure is not to be construed as being limited to the drawings:

FIG. 1 is a perspective view schematically showing a configuration of a battery module according to an embodiment of the present invention;

FIG. 2 is a perspective view schematically showing a configuration of a battery cell according to an embodiment of the present invention;

FIG. 3 is a cross-sectional view schematically showing the configuration of the battery cell of FIG. 2;

FIGS. 4 and 5 are partially enlarged perspective views schematically showing a bus bar holder according to an embodiment of the present invention;

FIG. 6 is a partially enlarged perspective view schematically showing the bus bar holder in which a bus bar according to an embodiment of the present invention is mounted;

FIG. 7 is a partially enlarged plan view schematically showing the bus bar holder in which the bus bar is mounted;

FIG. 8 is a cross-sectional view schematically showing the bus bar holder in which the bus bar is mounted;

FIG. 9 is a perspective view schematically showing a configuration of a battery module according to another embodiment of the present invention;

FIGS. 10 and 11 are partially enlarged perspective views schematically showing a bus bar holder of the battery module of FIG. 9;

FIG. 12 is a partially enlarged perspective view schematically showing the bus bar holder of FIGS. 10 and 11 in which a bus bar is mounted;

FIG. 13 is a partially enlarged plan view schematically showing the bus bar holder of FIGS. 10 and 11 in which the bus bar is mounted; and

FIG. 14 is a cross-sectional view schematically showing the bus bar holder of FIGS. 10 and 11 in which the bus bar is mounted.

### DETAILED DESCRIPTION

Herein, some embodiments of the present disclosure will be described, in further detail, with reference to the accompanying drawings. The terms or words used in this specification and claims are not to be construed as being limited to the usual or dictionary meaning and are to be interpreted as having a meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer, or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein are to be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

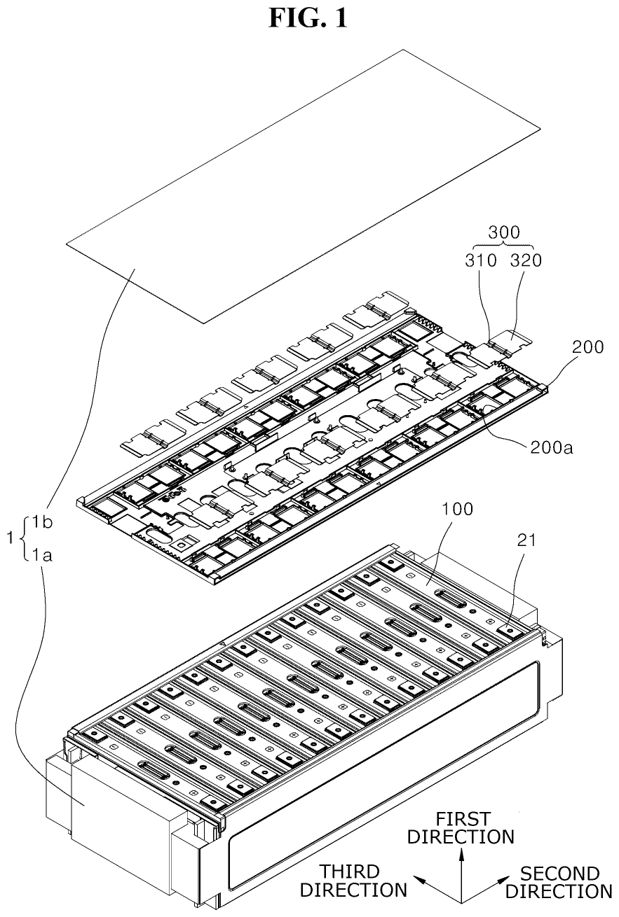

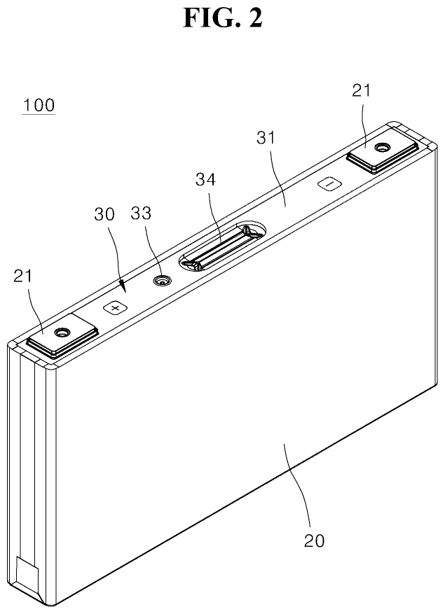

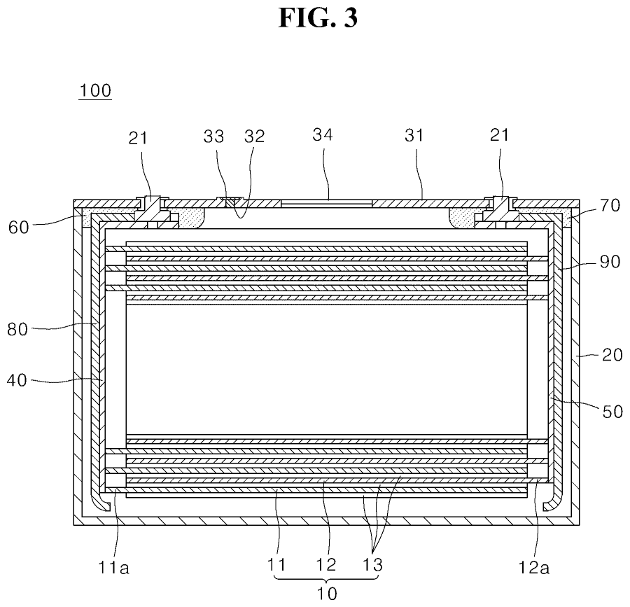

FIG. 1 is a perspective view schematically showing a configuration of a battery module according to an embodiment of the present invention; FIG. 2 is a perspective view schematically showing a configuration of a battery cell according to an embodiment of the present invention; and FIG. 3 is a cross-sectional view schematically showing the configuration of the battery cell of FIG. 2.

Referring to FIGS. 1 to 3, the battery module according to the present embodiment may include a housing 1, a battery cell 100, a bus bar holder 200, and a bus bar 300.

The housing 1 may support the battery cell 100 and protect the battery cell 100 from an external impact and foreign substances. The housing 1 may provide a space in which the battery cell 100 is accommodated.

The housing 1 may include a housing body 1a and a housing cover 1b.

The housing body 1a may be formed to have a shape of a box with an empty interior and an open side. For example, the open side of the housing body 1a may be disposed to face upward based on FIG. 1. However, a cross-sectional shape of the housing body 1a is not limited to the quadrangular shape shown in FIG. 1 and may have any of various shapes, such as polygonal, circular, and elliptical shapes.

The housing cover 1b may be coupled to the housing body 1a to close an internal space of the housing body 1a. For example, the housing cover 1b may be formed to have a substantially plate shape. The housing cover 1b may be disposed to face the open side of the housing body 1a, for example, an upper side surface of the housing body 1a. The housing cover 1b may be fixed to the housing body 1a by any of various types of coupling methods, such as bolting, welding, and fitting.

The battery cell 100 may be a unit structure that stores and supplies power in the battery module. The battery cell 100 may be disposed inside the housing 1.

One or more battery cells 100 may be provided. In FIG. 1, a case in which a plurality of battery cells 100 is provided is shown as an example, but the battery cell 100 is not limited thereto, and a single battery cell may be provided.

If a plurality of battery cells 100 is provided, the plurality of battery cells 100 may be arranged in multiple rows inside the housing 1. For example, the plurality of battery cells 100 may be arranged in multiple rows in a longitudinal direction (a second direction based on FIG. 1) of the housing 1. However, an arrangement form of the plurality of battery cells 100 is not limited thereto and the battery cells may be arranged in multiple rows in a width direction (a third direction based on FIG. 1) of the housing 1 or in multiple rows in both the longitudinal and width directions of the housing 1.

Herein, an example in which the battery cell 100 is a prismatic lithium-ion secondary battery will be described. However, the present invention is not limited thereto, and the battery cell 100 may be a lithium polymer battery or a cylindrical battery, for example.

The battery cell 100 may include one or more electrode assemblies 10 that are wound with a positive electrode 11, a negative electrode 12, and a separator 13 that is an insulator and interposed therebetween, a case 20 in which the electrode assembly 10 is accommodated, and a cap assembly 30 coupled to an opening of the case 20.

The positive electrode 11 and the negative electrode 12 may include a coated portion that is an area in which an active material is applied on a current collector formed of a thin metal foil, and uncoated portions 11a and 12a that are areas in which the active material is not applied thereon.

The positive electrode 11 and the negative electrode 12 may be wound after interposing the separator 13, which is an insulator, therebetween. However, the present invention is not limited thereto, and the electrode assembly 10 may have a structure formed by alternately stacking the positive electrode 11 and the negative electrode 12, which are made of a plurality of sheets, with the separator 13 interposed therebetween.

The case 20 may form an overall exterior of the battery cell 100 and may be formed of a conductive metal, such as aluminum, an aluminum alloy, or nickel-plated steel. The case 20 may provide a space in which the electrode assembly 10 is accommodated.

The cap assembly 30 may include a cap plate 31 which covers the opening of the case 20, and the case 20 and the cap plate 31 may be made of a conductive material. Here, a cell terminal 21 electrically connected to the positive electrode 11 or the negative electrode 12 may be installed to protrude outward by passing through the cap plate 31.

In an embodiment, an outer circumferential surface of an upper column of the cell terminal 21 protruding outward from the cap plate 31 may be subjected to screw-processing and fixed to the cap plate 31 with a nut. However, the present invention is not limited thereto, and, in an embodiment, the cell terminal 21 may be rivet-coupled in a riveted structure or coupled by being welded to the cap plate 31.

In an embodiment, the cap plate 31 may be formed of a thin plate and coupled to the opening of the case 20, and, in the cap plate 31, an electrolyte injection hole 32 in which a sealing plug 33 may be installed may be formed, and a vent 34 with a notch may be installed.

The vent 34 may be opened and closed in response to a change in internal pressure of the case 20. That is, the vent 34 may maintain a closed state during normal operation of the electrode assembly 10 to seal the case 20. The vent 34 may be opened as the internal pressure of the case 20 increases to a certain magnitude (e.g., a set magnitude) or higher due to overcharging, fires, etc., and may discharge emissions, such as flames and gas, from the inside to the outside of the case 20.

In an embodiment, the cell terminal 21 may be electrically connected to a current collector including first and second current collectors 40 and 50 (herein referred to as positive and negative electrode current collectors) that are joined to a positive electrode uncoated portion 11a or a negative electrode uncoated portion 12a by welding.

For example, the cell terminal 21 may be coupled to the positive and negative current collectors 40 and 50 by welding. However, the present invention is not limited thereto, and the cell terminal 21 and, in an embodiment, the positive and negative current collectors 40 and 50 may be formed by being integrally combined.

In an embodiment, an insulating member may be installed between the electrode assembly 10 and the cap plate 31. Here, the insulating member may include first and second lower insulating members 60 and 70, and each of the first and second lower insulating members 60 and 70 may be installed between the electrode assembly 10 and the cap plate 31.

In addition, according to an embodiment, an end of a separating member that may be installed opposite to a side surface of the electrode assembly 10 may be installed between the insulating member and the cell terminal 21. The separating member may include first and second separating members 80 and 90.

Therefore, ends of the first and second separating members 80 and 90 that may be installed opposite to the side surface of the electrode assembly 10 may be installed between the first and second lower insulating members 60 and 70 and the cell terminal 21.

As a result, the cell terminals 21 that are coupled to the positive and negative current collectors 40 and 50 by welding may be coupled to ends of the first and second lower insulating members 60 and 70 and the first and second separating members 80 and 90.

The cell terminal 21 may be provided on an upper surface of the battery cell 100. The cell terminal 21 may protrude from the upper surface of the battery cell 100 in a first direction. The cell terminal 21 may protrude upward from the upper surface of the battery cell 100 in a direction in which the bus bar holder 200 to be described below is located.

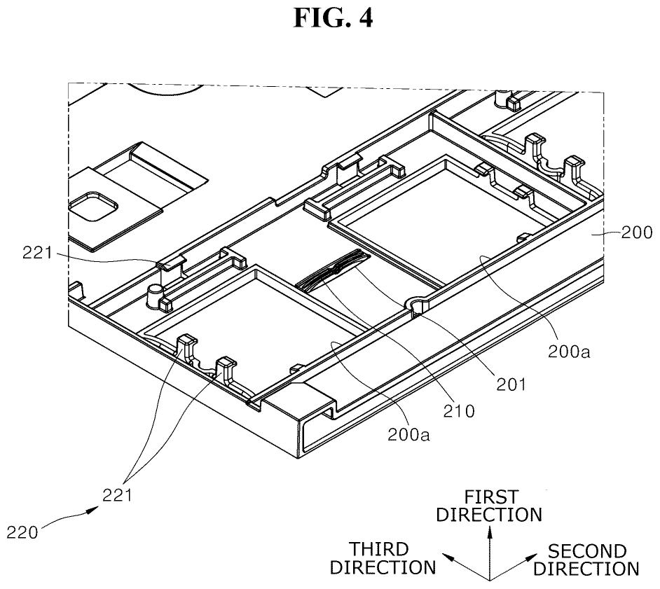

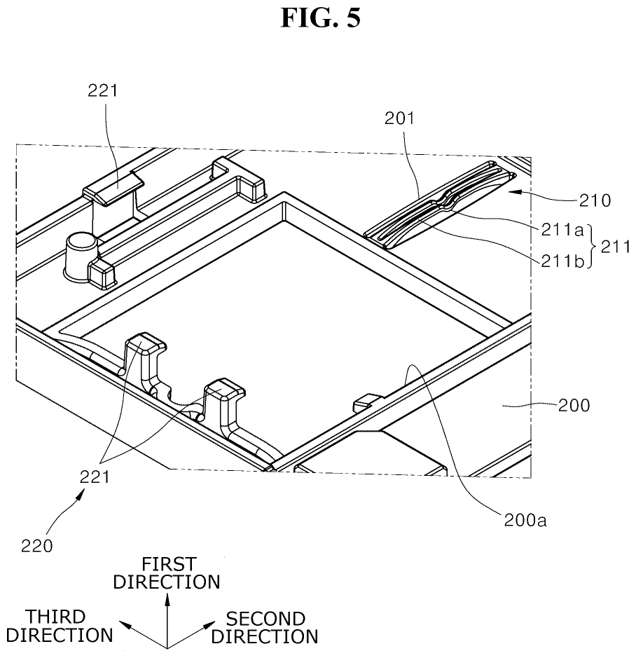

A pair of cell terminals 21 may be provided. In an embodiment, the pair of cell terminals 21 may be symmetrically disposed at both, or opposite, sides of the battery cell 100. The pair of cell terminals 21 may have different polarities. FIGS. 4 and 5 are partially enlarged perspective views schematically

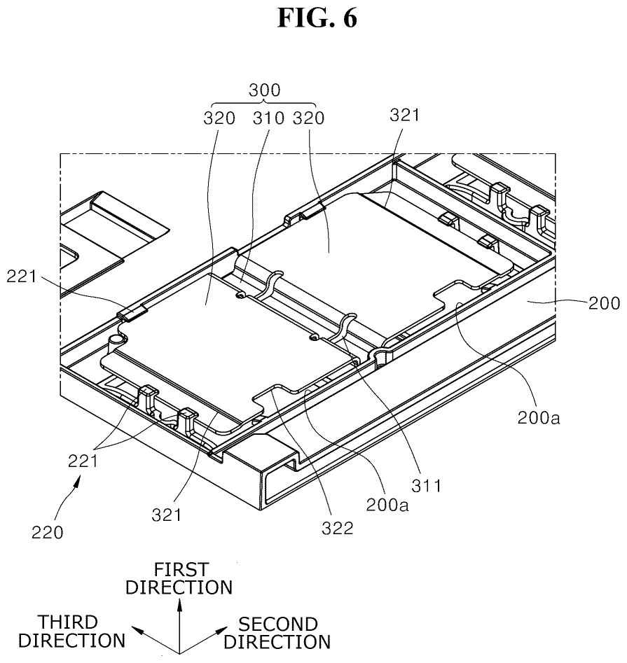

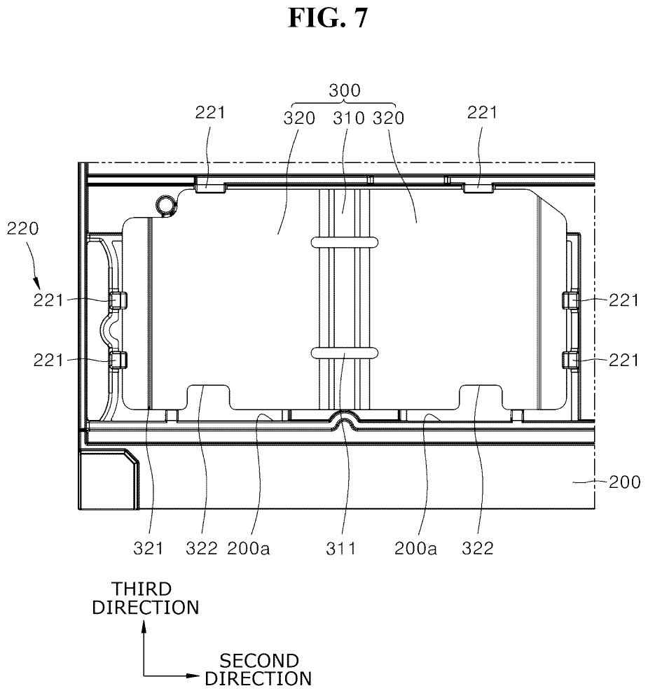

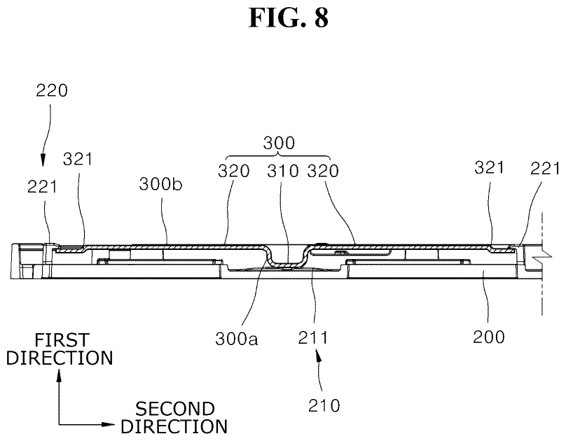

showing a bus bar holder according to an embodiment of the present invention; FIG. 6 is a partially enlarged perspective view schematically showing the bus bar holder in which a bus bar according to an embodiment of the present invention is mounted; FIG. 7 is a partially enlarged plan view schematically showing the bus bar holder in which the bus bar is mounted; and FIG. 8 is a cross-sectional view schematically showing the bus bar holder in which the bus bar is mounted.

Referring to FIGS. 1 to 8, the bus bar holder 200 may be disposed above the battery cell 100. In an embodiment, the bus bar holder 200 may be formed to have a generally flat plate shape. The bus bar holder 200 may be disposed such that both, or opposite, sides thereof face each other in parallel to a lower surface of the housing cover 1b and the upper surface of the battery cell 100.

The bus bar holder 200 may be provided with an opening 200a. The opening 200a may be formed by passing through the bus bar holder 200 in a thickness direction. The cell terminal 21 may be exposed through the opening 200a.

A plurality of openings 200a may be disposed to be spaced apart from each other in a longitudinal direction of the bus bar holder 200. The openings 200a may be disposed in a second direction that is the same as an arrangement direction of the battery cells 100.

In an embodiment, the plurality of openings 200a may be disposed to individually face the plurality of cell terminals 21.

The bus bar 300 may be supported by the bus bar holder 200. The bus bar 300 may cover the opening 200a of the bus bar holder 200. The bus bar 300 may be formed of an electrically conductive material, such as any of copper, aluminum, and nickel.

A plurality of bus bars 300 may be provided. The plurality of bus bars 300 may be individually connected to the plurality of cell terminals 21 to connect the plurality of battery cells 100 in series or parallel.

The bus bar 300 may include a first surface 300a and a second surface 300b disposed in a direction opposite to the first surface 300a. Here, the first surface 300a may be a lower surface of the bus bar 300 facing the battery cell 100, and the second surface 300b may be an upper surface of the bus bar 300.

The bus bar 300 may include a first bending portion 310 and a plate 320.

The first bending portion 310 may be formed to be bent in a direction opposite to the first direction. The first bending portion 310 may be formed in a downwardly bent shape. The first bending portion 310 may be disposed to face a first support portion 210 of the bus bar holder 200 and may be in contact with the first support portion 210.

The first bending portion 310 may be provided with a slit hole portion 311. The slit hole portion 311 may pass through the first bending portion 310 in a thickness direction and may be formed in the second direction intersecting the first direction. Here, the second direction may be a same direction as the arrangement direction of the battery cells 100 and the longitudinal direction of the bus bar holder 200.

A plurality of slit hole portions 311 may be disposed to be spaced apart from each other in the third direction intersecting the first and second directions. Here, the third direction may be a same direction as a width direction of the battery cells 100 and a width direction of the bus bar holder 200.

In an embodiment, a pair of plates 320 may be provided. The pair of plates 320 may be respectively provided at both, or opposite, sides of the first bending portion 310. In an embodiment, the pair of plates 320 may be formed to have a generally flat plate shape.

The pair of plates 320 may cover each opening 200a. The pair of plates 320 may be in contact with the cell terminals 21 of the battery cell 100. In an embodiment, the pair of plates 320 may each be connected to the cell terminals 21 by welding. In a welding process, the pair of plates 320 may be in contact with the cell terminals 21 when the bus bar 300 is pressed in a direction opposite to the first direction.

In an embodiment, the first bending portion 310 is formed to be bent, and if a load is applied in the second direction and the bus bar 300 is deformed in the second direction, deformation of the bus bar 300 can be absorbed, and even if the battery cell 100 swells, movement of the bus bar 300 can be also absorbed, thereby preventing or substantially preventing damage to the bus bar 300.

Since the slit hole portion 311 is formed in the first bending portion 310, if a load is applied in third direction and the bus bar 300 is deformed in the third direction, deformation of the bus bar 300 can be absorbed, and even if the battery cell 100 swells, movement of the bus bar 300 can be absorbed, thereby preventing or substantially preventing damage to the bus bar 300.

The pair of plates 320 may further be provided with a second bending portion 321. The second bending portion 321 may be formed to be bent in the first direction. The second bending portion 321 may be formed in an upwardly bent shape.

In an embodiment, the second bending portions 321 bent in a direction opposite to a bending direction of the first bending portion 310 are respectively formed on the pair of plates 320, and sufficient clearance between the pair of plates 320 and the battery cell 100 can be secured, thereby minimizing or reducing interference with the battery cell 100.

The bus bar 300 may further be provided with a welding inspection hole 322. The welding inspection hole 322 may be formed by passing through the plate 320 in the thickness direction. In an embodiment, the welding inspection hole 322 may be formed at an edge of each of the pair of plates 320. A welding state between the cell terminal 21 and the plate 320 can be checked through the welding inspection hole 322.

The bus bar holder 200 may be provided with the first support portion 210 and the second support portion 220.

The first support portion 210 may be in contact with the first surface 300a of the bus bar 300. The first support portion 210 may press the bus bar 300 in the first direction. The first support portion 210 may press the bus bar 300 upward.

The bus bar holder 200 may be provided with a through-hole portion 201. The through-hole portion 201 may pass through the bus bar holder 200 in the thickness direction and may be formed in the second direction. The through-hole portion 201 may be disposed between the plurality of openings 200a. The first support portion 210 may be located in an inner area of the through-hole portion 201.

The first support portion 210 may protrude from the bus bar holder 200 in the first direction. The first support portion 210 may be disposed to face the first bending portion 310 of the bus bar 300.

The first support portion 210 may include an elastic portion 211 that elastically supports the first bending portion 310. The elastic portion 211 may include a first body portion 211a and a second body portion 211b.

The first body portion 211a may be formed to be bent in a direction opposite to the first direction. The first body portion 211a may be formed in a downwardly bent shape.

The second body portions 211b may be provided at both, or opposite, sides of the first body portion 211a. End portions of the pair of second body portions 211b may each be connected to an inner surface of the through-hole portion 201. The second body portion 211b may be formed to be bent in the first direction. The second body portion 211b may be formed in an upwardly bent shape.

Since the elastic portion 211 that elastically supports the first bending portion 310 of the bus bar 300 is located in an inner area of the through-hole portion 201, when a load is applied in the first direction and the direction opposite to the first direction and the bus bar 300 is deformed, deformation and movement of the bus bar 300 can be absorbed, thereby preventing or substantially preventing damage to the bus bar 300.

The second support portion 220 may be disposed to be spaced apart from the first support portion 210. The second support portion 220 may be formed to extend from the bus bar holder 200 in the first direction.

The second support portion 220 may be in contact with the second surface 300b of the bus bar 300. The second support portion 220 may press the bus bar 300 in the direction opposite to the first direction. The second support portion 220 may press the bus bar 300 downward. The second support portion 220 may extend upward from the bus bar holder 200.

The plurality of second support portions 220 may be disposed to be spaced apart from each other along an edge of the opening 200a. The second support portions 220 may be in contact with the pair of plates 320. In an embodiment, the second support portion 220 may include hooks 221 that are caught on and come in contact with edges of the pair of plates 320.

The second support portions 220 may support the pair of plates 320 in the direction opposite to the first direction, thereby preventing or substantially preventing the bus bar 300 from being detached from the bus bar holder 200 in the first direction.

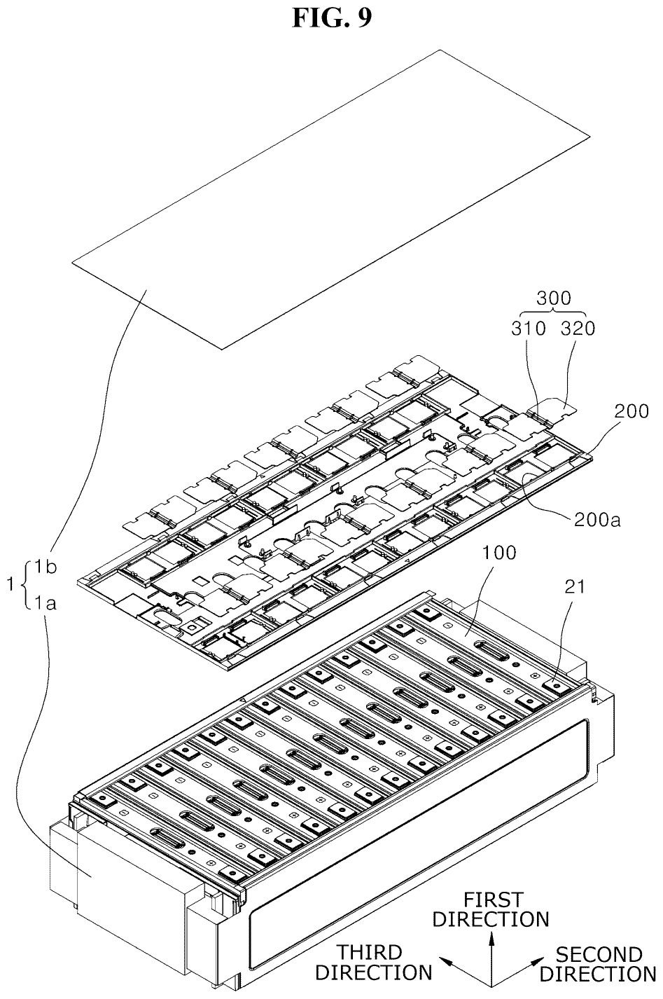

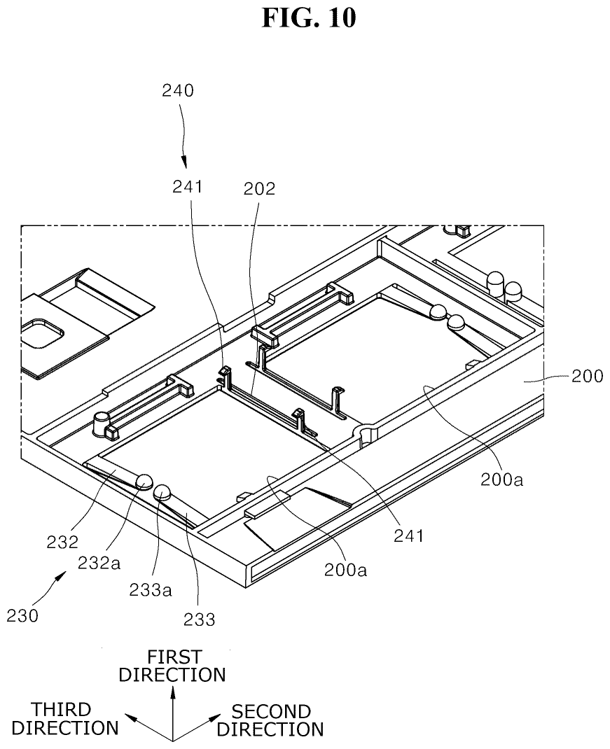

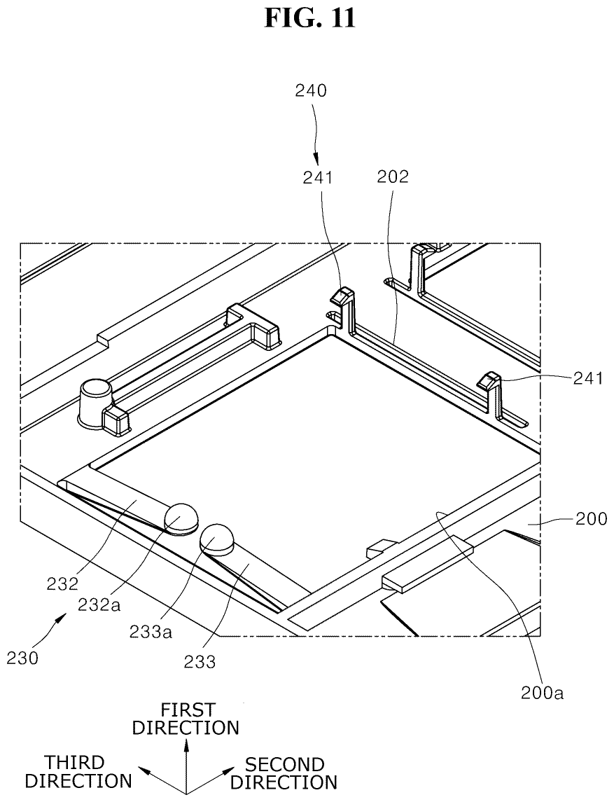

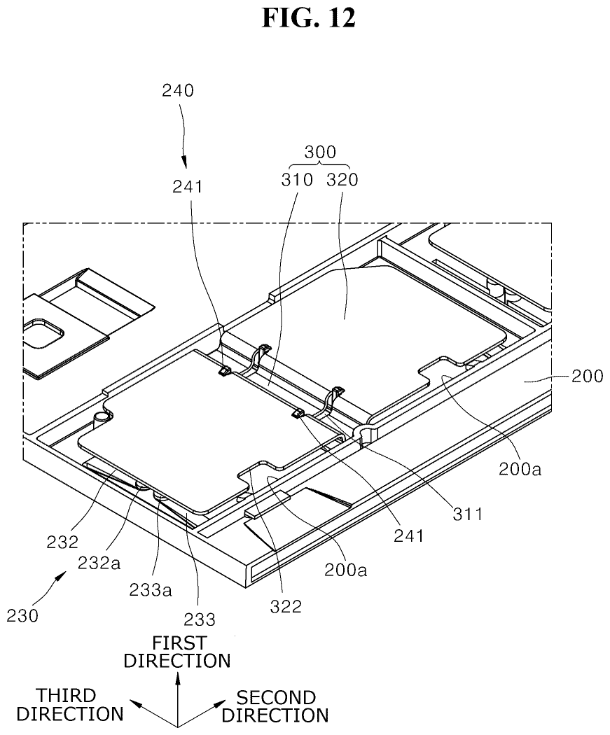

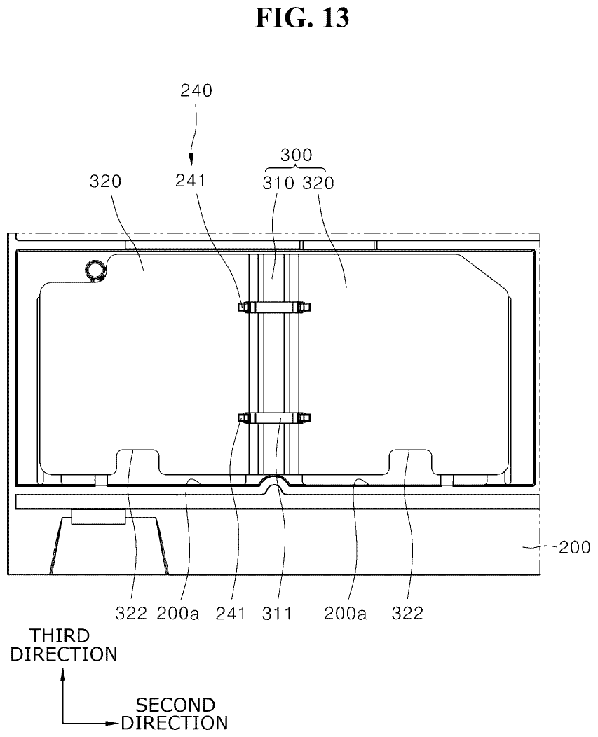

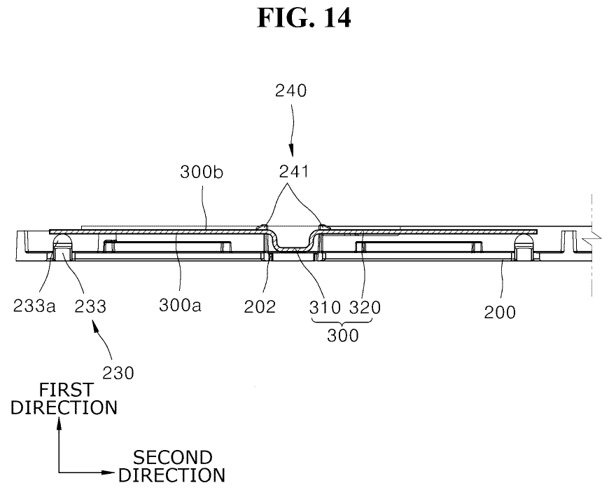

FIG. 9 is a perspective view schematically showing a configuration of a battery module according to another embodiment of the present invention; FIGS. 10 and 11 are partially enlarged perspective views schematically showing a bus bar holder of the battery module of FIG. 9; FIG. 12 is a partially enlarged perspective view schematically showing the bus bar holder of FIGS. 10 and 11 in which a bus bar according to an embodiment of the present invention is mounted; FIG. 13 is a partially enlarged plan view schematically showing the bus bar holder of FIGS. 10 and 11 in which the bus bar is mounted; and FIG. 14 is a cross-sectional view schematically showing the bus bar holder of FIGS. 10 and 11 in which the bus bar is mounted.

Referring to FIGS. 9 to 14, the battery module according to the present embodiment of the present invention may include a housing 1, a battery cell 100, a bus bar holder 200, and a bus bar 300.

In describing the battery module according to the present embodiment of the present invention, another embodiment of the bus bar holder 200 in the battery module according to the previously described embodiment of the present invention will be described.

The description of the battery module according to the previously described embodiment of the present invention may be applied to a remaining configuration of the battery module according to the present embodiment of the present invention.

The bus bar holder 200 may be provided with a first support portion 230 and a second support portion 240.

The first support portion 230 may be in contact with a first surface 300a of the bus bar 300. The first support portion 230 may press the bus bar 300 in the first direction. The first support portion 230 may press the bus bar 300 upward.

The first support portion 230 may protrude from the bus bar holder 200 in the first direction. The first support portion 230 may be disposed to face a plate 320 of the bus bar 300. The first support portion 230 may be disposed at an edge of an opening 200a.

The first support portion 230 may include a first elastic portion 232, a second elastic portion 233, and seating protrusions 232a and 233a.

The first elastic portion 232 may be provided at a side edge of the opening 200a and may extend obliquely from the bus bar holder 200 in the first direction. The first elastic portion 232 may elastically support the plate 320 of the bus bar 300.

The second elastic portion 233 may face the first elastic portion 232 and may be disposed to be spaced apart from the first elastic portion 232. The second elastic portion 233 may be provided at another side edge of the opening 200a and may extend obliquely from the bus bar holder 200 in the first direction. An extending direction of the first elastic portion 232 may be opposite to an extending direction of the second elastic portion 233. The second elastic portion 233 may elastically support the plate 320 of the bus bar 300.

The seating protrusions 232a and 233a may be formed to respectively protrude from a free end of the first elastic portion 232 and a free end of the second elastic portion 233. The plate 320 of the bus bar 300 may be seated on the seating protrusions 232a and 233a.

The second support portion 240 may be disposed to be spaced apart from the first support portion 230. The second support portion 240 may be formed to extend from the bus bar holder 200 in the first direction.

The second support portion 240 may be in contact with a second surface 300b of the bus bar 300. The second support portion 240 may press the bus bar 300 in the direction opposite to the first direction. The second support portion 240 may press the bus bar 300 downward. The second support portion 240 may extend upward from the bus bar holder 200.

The second support portion 240 may be disposed between the plurality of openings 200a. A plurality of second support portions 240 may be disposed to be spaced apart from each other in the third direction.

The second support portions 240 may be in contact with a pair of plates 320. In an embodiment, the second support portions 240 may include hooks 241 that pass through a slit hole portion 311 and are caught on and come in contact with the pair of plates 320.

The second support portions 240 may support the pair of plates 320 in the direction opposite to the first direction, thereby preventing or substantially preventing the bus bar 300 from being detached from the bus bar holder 200 in the first direction.

The bus bar holder 200 may further be provided with a recessed hole 202. The recessed hole 202 may be formed between the plurality of openings 200a. The recessed hole 202 may be formed in the shape of a long hole in the third direction. The long recessed hole 202 may be disposed at a side of the second support portion 240 to allow deformation of the second support portion 240 to facilitate mounting of the bus bar 300 in the bus bar holder 200.

The bus bar 300 may include a first bending portion 310 and the plate 320.

The first bending portion 310 may be formed to be bent in a direction opposite to the first direction. The first bending portion 310 may be formed in a downwardly bent shape.

The first bending portion 310 may be provided with the slit hole portion 311. The second support portion 240 may pass through the slit hole portion 311.

In an embodiment, a pair of plates 320 may be provided. The pair of plates 320 may be respectively provided at both, or opposite, sides of the first bending portion 310. The pair of plates 320 may be disposed to face the first support portion 230.

According to one or more embodiments of the present invention, by fixing a bus bar in a bus bar holder in a vertical direction, an assembly tolerance can be increased, a fixing force in the vertical direction can be increased, and if acquiring electrical characteristics of a battery cell, exposure of a circuit to an abnormal situation due to abnormal contact with the battery cell can be prevented or substantially prevented.

However, aspects and effects obtainable through the present disclosure are not limited to the above aspects and effects, and other technical aspects and effects that are not mentioned will be clearly understood by those skilled in the art from the following description of the present disclosure.

Although the present invention has been described with reference to some embodiments and drawings illustrating aspects thereof, the present invention is not limited thereto. Various modifications and variations can be made by a person skilled in the art to which the present invention belongs within the scope of the technical spirit of the present invention and the claims and equivalents thereto.

What is claimed is:

1. A battery module comprising:
a housing;
one or more battery cells arranged in the housing and comprising a cell terminal;
a bus bar holder above the one or more battery cells and comprising an opening through which the cell terminal is exposed; and
a bus bar supported by the bus bar holder, connected to the cell terminal, and comprising a first surface and a second surface located in a direction opposite to the first surface,
wherein the bus bar holder comprises a first support portion that is in contact with the first surface, and a second support portion spaced apart from the first support portion and in contact with the second surface.

2. The battery module as claimed in claim 1, wherein the first support portion presses the bus bar in a first direction, and the second support portion presses the bus bar in a direction opposite to the first direction.

3. The battery module as claimed in claim 2, wherein the bus bar comprises:
a first bending portion bent in the direction opposite to the first direction; and
a pair of plates at opposite sides of the first bending portion, covering the opening, and in contact with the cell terminal.

4. The battery module as claimed in claim 3, wherein the pair of plates comprise a second bending portion bent in the first direction.

5. The battery module as claimed in claim 3, wherein the first support portion protrudes from the bus bar holder in the first direction and comprises an elastic portion that elastically supports the first bending portion.

6. The battery module as claimed in claim 5, wherein the elastic portion comprises:
a first body portion bent in the direction opposite to the first direction; and
a second body portion at opposite sides of the first body portion and bent in the first direction.

7. The battery module as claimed in claim 3, wherein the bus bar holder comprises a through-hole portion formed in a second direction intersecting the first direction.

8. The battery module as claimed in claim 7, wherein the first bending portion comprises a slit hole portion formed in the second direction.

9. The battery module as claimed in claim 8, wherein the first support portion is located in an inner area of the through-hole portion.

10. The battery module as claimed in claim 9, wherein the through-hole portion is located between a plurality of openings.

11. The battery module as claimed in claim 8, wherein the second support portion comprises a hook that extends from the bus bar holder in the first direction and is caught on and in contact with the pair of plates.

12. The battery module as claimed in claim 11, wherein a plurality of second support portions are spaced apart from each other along an edge of the opening.

13. The battery module as claimed in claim 11, wherein the second support portion passes through the slit hole portion.

14. The battery module as claimed in claim 13, wherein the second support portions are between the plurality of openings.

15. The battery module as claimed in claim 14, wherein the bus bar holder comprises a recessed hole between the plurality of openings.

16. The battery module as claimed in claim 15, wherein the recessed hole is formed in a third direction intersecting the first direction and the second direction.

17. The battery module as claimed in claim 3, wherein the first support portion comprises:
a first elastic portion extending obliquely from the bus bar holder in the first direction; and
a second elastic portion facing the first elastic portion, spaced apart from the first elastic portion, and extending obliquely from the bus bar holder in the first direction.

18. The battery module as claimed in claim 17, wherein the first support portion further comprises a seating protrusion protruding from free ends of the first elastic portion and the second elastic portion and on which the plate is seated.

19. The battery module as claimed in claim 17, wherein the first support portion is located at an edge of the opening.
